(19) United States
(12) Patent Application Publication
(10) Pub. No.: US 2005/0001338 A1
(43) Pub. Date: Jan. 6, 2005

(54) Built-in element for a cooling tower

(76) Inventors: Helgo Hagemann, Ochtrup (DE); Javier Vaquero Galvan, E-Madrid (ES); Enrique Aguirre Abarquero, San Sebastian de los Reyes (Madrid) (ES); Luis Elechguerra Martinez, Madrid (ES); Carlos Dolz de Espero y Arrospide, Madrid (ES)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/723,895

(22) Filed: Nov. 26, 2003

(30) Foreign Application Priority Data
Jul. 1, 2003 (DE) 103 29 815.0

(51) Int. Cl. B01F 3/04

(52) U.S. Cl. 261/108; 261/112.2; 261/DIG. 11; 261/DIG. 46; 261/DIG. 72

(57) ABSTRACT

A built-in element for a cooling tower is made of a plastic material and is equipped with an additive with anti-bacterial activity. The additive may be embedded in the plastic material of the built-in element, or may be applied to an exterior of the element.

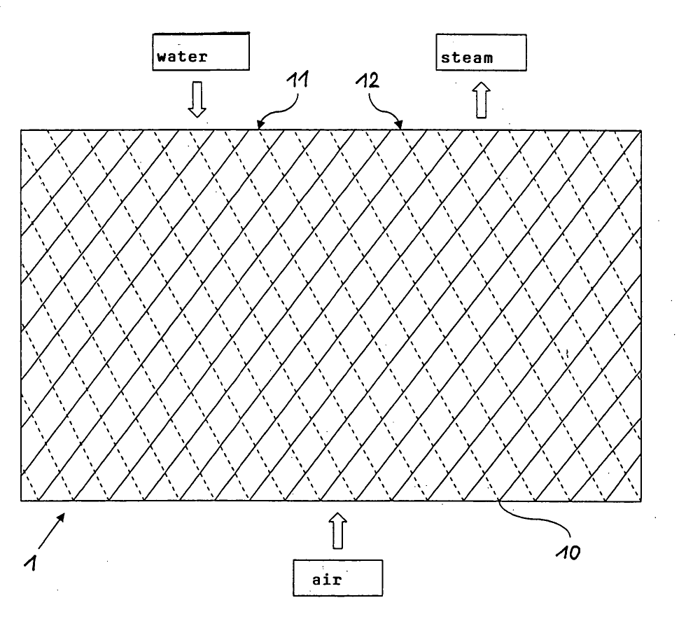

### BACKGROUND OF THE INVENTION

The present invention relates to a built-in element for a cooling tower, in particular a cooling tower fill or mist eliminator or air inlet element, whereby the built-in element is made of a plastic material and, in its built-in state in the cooling tower, contacts water circulating within the cooling tower.

The ambient conditions inside a cooling tower are characterised by very high atmospheric humidity and a proper temperature to support the strong growth and proliferation of micro-organisms in the absence of pertinent countermeasures. Since a cooling tower does not constitute a closed system, micro-organisms may be released therefrom jointly with steam or water droplets exiting the cooling tower. This release of micro-organisms can be a hazard to human beings in the vicinity of the cooling tower, for instance if the micro-organisms comprise legionellae, i.e. the pathogens of the perilous Legionnaire's disease. Moreover, it is known that the growth of micro-organisms on the built-in elements of a cooling tower negatively affects the desired heat exchange between water and air and thus impairs the function of the built-in elements and, therefore, the overall efficiency of the cooling tower.

In order to remedy the problems described above, it has been common to shut down the cooling tower from time to time, disassemble the built-in elements, and replace the elements by new or cleaned and disinfected built-in elements. This procedure is disadvantageous due to the operational standstill of the cooling tower for a certain period of time and the extensive utilization of resources for disassembly and re-assembly of the built-in elements.

A method for the elimination of bacteria, fungi, viruses, etc. from cooling towers is known from DE 35 23 594 A1, which proposes to add flue gas from a fossil fuel combustion zone to the cooling tower exhaust gases at certain desired pre-set dosages either in the form of total crude gas or, in interacting dosages, with a content of S02 and/or Noₓ. For this method to be feasible, it is required that a fossil fuel combustion zone is committed to the cooling tower. In practical application, this means that the method can be applied only in conventional power plants, in which electrical energy is produced from fossil fuels, such as crude oil, natural gas or coal. Another disadvantage of this known method is that components of the flue gas from the fossil fuel combustion zone are released into the environment by way of the cooling tower which is undesirable as it negatively affects the air quality in the vicinity of the cooling tower. And finally, another disadvantage of the method to be mentioned is that the introduction of the flue gas changes the pH of the water circulating in the cooling tower, which may lead to increased corrosion on water-bearing parts of the cooling water cycle.

It is therefore the task of the present invention to provide a built-in element of the type described above that is not associated with the disadvantages listed above and, in contrast, rather, reduces or even prevents the growth and proliferation of micro-organisms, in particular disease-eliciting bacteria, such as legionellae, on the surface of a cooling tower fill, drift eliminator, and air inlet element, and in the cooling water of the cooling tower.

### SUMMARY OF THE INVENTION

This task is solved by the present invention by a built-in element that is equipped with an additive with antibacterial activity.

According to the invention, the additive with antibacterial activity is introduced jointly with the built-in element into the cooling tower and, therefore, in some way also into the water cycle of the cooling tower. Accordingly, the additive prevents or reduces the growth and proliferation of micro-organisms, in particular bacteria, both on the surfaces of the built- in elements and in the water contacting the built-in elements.

Consequently, the risk of releasing disease-eliciting bacteria or other detrimental micro-organisms from the cooling tower is reduced such that there is less infection risk for human beings in the vicinity of the cooling tower.

In a first embodiment of the built-in element according to the present invention, the additive with antibacterial activity is further provided to be embedded in the plastic material of which the built-in element is made, and can be released therefrom into the water contacting the built-in element. In this embodiment of the built-in element, the additive with antibacterial activity initially resides within the plastic material of which the built-in element is made and later the additive is gradually leaching to the surface and there from released into the water. This provides for the desired antibacterial activity being maintained over extended periods of time such that it can be guaranteed for economically reasonable periods of time that the cooling tower fill is free of bacteria or at least contains only few bacteria and poses no hazard.

Moreover, the present invention proposes that the built-in element is made of one or several extruded or injection moulded plastic components and that the additive with anti- bacterial activity is added to the plastic material prior to extrusion or injection molding. This embodiment of the built-in element provides for particularly good embedding of the additive with antibacterial activity in the plastic material and correspondingly slow leaching to the surface and release of the additive into the water circulating in the cooling tower over a long, economically reasonable period of time.

To provide for simple handling and processing, it is preferred to add the additive with antibacterial activity to the plastic material in the form of a dry granulate or powder.

Alternatively, the additive with antibacterial activity can also be added to the plastic material in the form of a liquid or paste.

In either case, the addition of the additive to the plastic material prior to extrusion or injection molding provides for intensive mixing and homogeneous distribution of the additive in the plastic material which promotes the temporally and spatially homogeneous release of the additive into the water. The addition of the additive has little influence on the properties of the plastic material, since the fraction of additive required to achieve the desired effect is relatively small compared to the total quantity of the plastic material.

An alternative embodiment of the built-in element according to the present invention provides for the additive with antibacterial activity to be applied onto the plastic material of which the built-in element has been made, and be releasable therefrom into the water contacting the built-in element. In this case, it is self-evident that the solubility of the additive should be suitably adjusted such that the additive is released over a desired extended period of time rather than being completely or largely dissolved in the water after only a short time of contact between the built-in element and the water.

A further development of the latter embodiment of the built-in element provides for the additive with antibacterial activity to be applied in the form of a liquid onto the plastic material of which the built-in element is made, and to be dried thereafter. The application of the additive in the form of a liquid ensures that the plastic material of which the built-in element is made is coated with a layer of the additive that is homogeneous in thickness, which is of advantage for the desired function of the built-in element.

A further development of the latter built-in element provides for the additive with antibacterial activity to be applied by immersion or painting of the plastic material of which the built-in element is made. Immersion and painting are techniques for the generation of an additive coating on the plastic material of which the built-in element is made that are characterised by their good handling features allowing the desired coating to be produced both safely and at a reasonable utilisation of resources.

It is also preferred according to the present invention to suitably adjust the quantity and solubility of the additive with antibacterial activity and/or the permeability of the plastic material of which the built-in element is made with regard to the additive with antibacterial activity such that effective concentrations of the additive with antibacterial activity are released into the water for several years. The stated period of several years comprises an economically reasonable period of time for the effect of the additive within the cooling tower to be maintained. In practical application, it is useful to check the antibacterial activity in regular intervals. Moreover, this procedure takes into consideration the fact that the consumption of the additive with antibacterial activity in a cooling tower depends on the operating conditions of the cooling tower, for example the quantity and temperature of the water flowing through the built-in elements.

To safely attain the desired effect it is preferred that the additive with antibacterial activity is a bactericidal agent or mixture of several bactericidal agents. A large number of bactericidal agents are available on the pertinent market and can be selected as the additive in or on a built-in element for the application according to the present invention on the basis of the required properties.

In case the bactericidal agent or mixture of several bactericidal agents as such fails to provide the desired properties, the present invention also provides for the bactericidal agent or mixture of several bactericidal agents to be embedded in a carrier substance with a suitable or suitably adjustable solubility in water. In this embodiment of the built-in element, the release of the additive with antibacterial activity from the built-in element into the water is determined not by the bactericidal agent or mixture of several bactericidal agents as such, but rather by the carrier substance and its solubility and dissolution rate in water.

Various materials are suitable for use for the plastic material of which the built-in element is made. In a first preferred embodiment, the plastic material comprises a thermoplastic material. This type of plastic material can be processed in the heated state in which the plastic material becomes plastic. Moreover, built-in elements can be reused after their service life, though they may need to be cleaned first, if required. Subsequently, the plastic material can be melted and recycled for a new use.

Suitable thermoplastic materials for built-in elements include for example polypropylene (PP), polyethylene (PE), acrylonitrile-butadiene-styrene (ABS) or polyvinylchloride (PVC).

Alternatively, the plastic material of which the built-in element is made may comprise a duroplastic material.

One embodiment of the built-in element according to the present invention is illustrated in the following on the basis of a drawing.

### BRIEF DESCRIPTION OF THE DRAWING

The single FIGURE of the drawing shows a schematic illustration of an built-in element in a side view.

### DETAILED DESCRIPTION OF THE PREFERRED EMBODIMENT

According to the drawing, built-in element 1 is a package comprising several structured layers 10 made of plastic material arranged parallel to each other and parallel to the plane of the drawing, said layers being provided in the form of films or thin plates that are connected to each other to form the package. The individual plastic layers 10 are provided with undulation 11 or 12 that extend(s) in an oblique direction, whereby undulations 11, 12 of adjacent layers 10 extend in different directions. As a result, a system of channels is generated inside built-in element 1, in which water supplied from above and air supplied from below may contact each other and contact built-in element 1 and exchange heat. Some of the water is converted to the vapor phase and drawn off in an upward direction. This steam then exits a cooling tower, in which a multitude of built-in elements 1 are arranged, and is released into the environment.

The humidity and temperature inside the cooling tower and inside each built-in element 1 are such that the growth and proliferation of micro-organisms, such as bacteria, are promoted, unless counter-measures are undertaken. In built-in element 1 shown, the countermeasure consists of equipping built-in element 1 with an additive with antibacterial activity. The additive with antibacterial activity is either admixed to the plastic material of which built-in element 1 or its layers 10 are made or applied to the surfaces of the plastic material. The circulating water gradually dissolves or washes out the additive and, accordingly, the additive is gradually transported from the inside of built-in element 1 or the surface of built-in element 1 into the circulating water. The additive with antibacterial activity exerts its antibacterial effect on the surface of built-in element 1 and in some way in the circulating water. This means that growth and proliferation of bacteria are prevented or at least reduced. Consequently, the number of disease-eliciting bacteria in the circulating water and on the surfaces of built-in elements 1 and especially in the water drops released from the cooling tower, is kept low. In particular, this can be utilised to counteract the release of legionellae, the cause of the perilous Legionnaire's disease.

Once the antibacterial activity drops below a threshold after a certain operating period, which should be on the order of several years, built-in elements 1 must be replaced by fresh built-in elements 1 with full antibacterial activity. If possible at reasonable cost, spent built-in elements 1 may be cleaned and re-coated with the additive with antibacterial activity and then re-installed.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

1. A built-in element for a cooling tower, the built-in element being made of a plastic material and, in its assembled state in the cooling tower, contacts water circulating within the cooling tower wherein the built-in element is equipped with an additive with antibacterial activity.

2. The built-in element according to claim 1, wherein the additive with anti- bacterial activity is embedded in the plastic material of which the built-in element is made in such a manner that the additive is leaching to the surface and released therefrom into the water contacting built-in element.

3. The built-in element according to claim 2, wherein the built-in element comprises at least one plastic part made by one of extrusion and injection molding and in that the additive with antibacterial activity is added to the plastic material prior to extrusion or injection molding.

4. The built-in element according to claim 3, wherein the additive with anti- bacterial activity is added to the plastic material in the form of a dry granulate or powder.

5. The built-in element according to claim 3, wherein the additive with anti- bacterial activity is added to the plastic material in the form of a liquid or paste.

6. The built-in element according to claim 1, wherein the additive with anti- bacterial activity is applied to an exterior of the plastic material of which the built-in element is made in such a manner that the additive is released therefrom into the water contacting built-in element.

7. The built-in element according to claim 6, wherein the additive with anti- bacterial activity is applied in the form of a liquid to the plastic material of which the built-in element is made, and is dried thereafter.

8. The built-in element according to claim 7, wherein the additive with anti- bacterial activity is applied by one of immersion and painting of the plastic material of which the built-in element is made.

9. The built-in element according to claim 1, wherein the quantity and solubility of the additive with antibacterial activity are suitably adjusted such that effective concentrations of the additive with antibacterial activity are released into the water for several months or longer.

10. The built-in element according to claim 3, wherein the permeability of the plastic material of which the built-in element is made is suitably adjusted such that effective concentrations of the additive with anti-bacterial activity are released into the water for at least several months.

11. The built-in element according to claim 1, wherein the additive with anti- bacterial activity is a single bactericidal agent.

12. The built-in element, according to claim 1, wherein the additive is a mixture of several bactericidal agents.

13. The built-in element according to claim 10, wherein the additive is embedded in a carrier substance with a suitable solubility in water.

14. The built-in element according to claim 1, wherein the plastic material of which the built-in element is made comprises a thermoplastic material.

15. The built-in element according to claim 12, wherein the thermoplastic material comprises one of the group consisting of polypropylene (PP), polyethylene (PE), acrylonitrile- butadiene-styrene (ABS) and polyvinylchloride (PVC).

16. The built-in element according to claim 1, wherein the plastic material of which the built-in element is made comprises a duroplastic material.

17. The built-in element according to claim 1, wherein the built-in element is a cooling tower fill.

18. The built-in element according to claim 1, wherein the built-in element is a mist eliminator.

19. The built-in element according to claim 1, wherein the built-in element is an air inlet element.
